(19) United States
(12) Patent Application Publication
(10) Pub. No.: US 2018/0078818 A1
(43) Pub. Date: Mar. 22, 2018

(54) WIRELESS NETWORK MONITORING SYSTEM

(71) Applicant: FOXCONN INTERCONNECT TECHNOLOGY LIMITED, Grand Cayman (KY)

(72) Inventors: SU-NUNG CHAO, New Taipei (TW); JUI-KUANG CHUNG, New Taipei (TW); HSU-HSUN HUANG, New Taipei (TW)

(21) Appl. No.: 15/708,059

(22) Filed: Sep. 18, 2017

(30) Foreign Application Priority Data
Sep. 18, 2016 (CN) 201610825696.0

(51) Int. Cl. A63B 24/00; G06Q 10/06

(52) U.S. Cl. CPC A63B 24/00; A63B 2225/50; G06Q 10/06

(57) ABSTRACT

An intelligent wireless network fitness monitoring/computing system which includes the data collection box, the gateway, the wireless RFID system, the Wi-Fi wireless network station and the server system. The Wi-Fi wireless network station is connected with the server system. The wireless RFID system is connected with the Wi-Fi wireless network station. The RFID system includes a tag and a card reader. The gateway and the data collection box are connected via the personal area network while the gateway and the Wi-Fi wireless network station mutually communicate with each other via the local area network or wide area network.

### BACKGROUND OF THE INVENTION

### 1. Field of the Invention

The present invention relates to the wireless network fitness monitoring system, and particularly to the intelligent wireless network fitness monitoring system. This application relates to the copending applications with the same filing date, the same applicant and the common inventors with the titles “TREADMILL AND MONITORING SYSTEM” and “WEIGHT TRAINING AND MONITORING SYSTEM”.

### 2. Description of Related Art

Fitness for either body building or body shaping is more and more popular while the equipments provided in the gym generally lack efficiently supervising or monitoring effects for the individual users.

### SUMMARY OF THE INVENTION

The invention is to provide an intelligent wireless network fitness monitoring/computing system which includes the data collection box, the gateway, the wireless RFID system, the Wi-Fi wireless network station and the server system. The Wi-Fi wireless network station is connected with the server system, the wireless RFID system is connected with the Wi-Fi wireless network station, the RFID system includes a tag and a card reader, the gateway and the data collection box are connected via the personal area network while the gateway and the Wi-Fi wireless network station mutually communicate with each other via the local area network or wide area network.

The fitness system further includes a plurality of sensors associated with the equipments. The data collection box sends the data derived from the sensors to the gateway via blue tooth.

The RF identification system includes a RF tag and a card reader wherein the RF tag corresponds to the user and the card reader corresponds to the individual treadmill. The RFID system sends the data to the server system via the Wi-Fi wireless network station for viewing under the browser or the Apps.

The monitoring/computing system further includes an intelligent power wherein the gateway and the intelligent power are wirelessly connected with each other via ZigBee.

When the user uses the card reader to read the personal RF tag, the wireless RF identification system may transmit the data to the Wi-Fi wireless network station, the data is further transmitted to the gateway via the Wi-Fi wireless station and the gateway may activate the intelligent power via ZigBee to have the equipments ready in use.

The data derived from the sensors are transmitted to the data collection box via ether the blue tooth or the USB wires. The data collection box transfers the data to the gateway via the blue tooth. The gateway further transmits the data to the Wi-Fi- wireless network station and eventually to the server system for viewing under browser or Apps and/or further analyzing and making adjustment.

The sensor may be directly mounted upon the corresponding equipments as one part thereof, or separately arranged aside.

The whole monitoring/computing system further includes a room circumstance sensor which is connected to the gateway via ZigBee.

The data derived from the room circumstance sensor are transmitted to the gateway and further transferred to the Wi-Fi wireless network station and eventually to the server system for viewing or analyzing.

The server system includes a web server which reads the data from the RFID system and the sensors and provides supports for web-browsing, and a data server stores the data

Compared with the traditional system, the invention performs the intelligent management by means of the data collection from both the user and the equipments wherein the Wi-Fi wireless network station mutually communicates with the gateway communicated via LAN (Local Area Network) or WAN (Wide Area Network), and communicates with the data collection box via PAN (Personal Area Network).

### BRIEF DESCRIPTION OF THE DRAWINGS

FIG. 1 is a flow chart of the wireless fitness monitoring/computing system.

FIG. 2 is the partial flow chart of FIG. 1 when the user is approaching the equipment;

FIG. 3 is the partial flow chart of FIG. 1 when the intelligent power is on;

FIG. 4 is the partial flow chart of FIG. 1 during sensing the room circumstance;

FIG. 5 is the partial flow chart of FIG. 1 when the user is operating the equipment;

FIG. 6 is an assembled perspective view of the data collection box for use with the system of FIG. 1;

FIG. 7 is an exploded perspective view of the data collection box of the treadmill of FIG. 6; and

FIG. 8 is another exploded perspective view of the data collection box of the treadmill of FIG.

### DETAILED DESCRIPTION OF THE PREFERRED EMBODIMENT

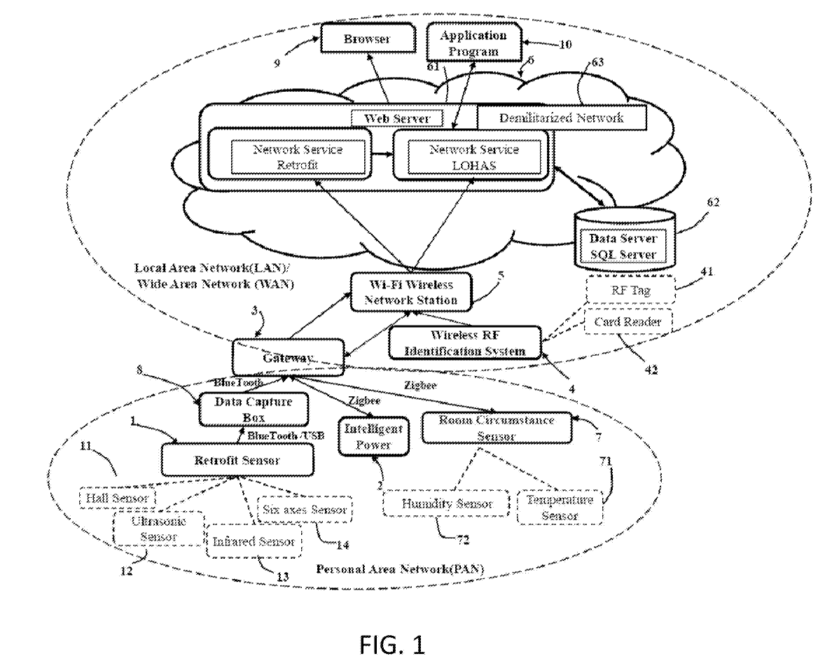

Referring to FIG. 1, the wireless fitness monitoring/computing system may by applied to different equipments and includes a plurality of sensors, a data collection box 8, an intelligent power (source), a room circumstance sensor, a gateway 3, an RFID (Radio Frequency Identification) system 4, a Wi-Fi wireless network station 5 and a server system 6.

The sensors 1 may be applied to the treadmill, weight-training device and bicycle, etc. The sensor 1 may detect the heartbeat, the pulse, the body temperature, the blood pressure, the blood sugar, the heart tempo, etc., or the speed, the distance, the slope, the step frequency and the effective times/cycles. The sensor may include the Hall sensor 11, the supersonic sensor 12, the Infrared sensor 13, and the six axes sensor 14. The sensors 1 can be one part of the equipment or separately disposed from the equipment and/or wearable with the user.

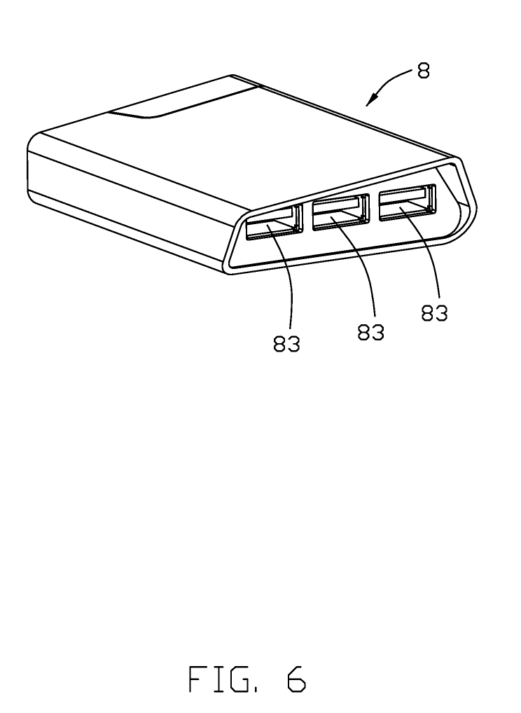

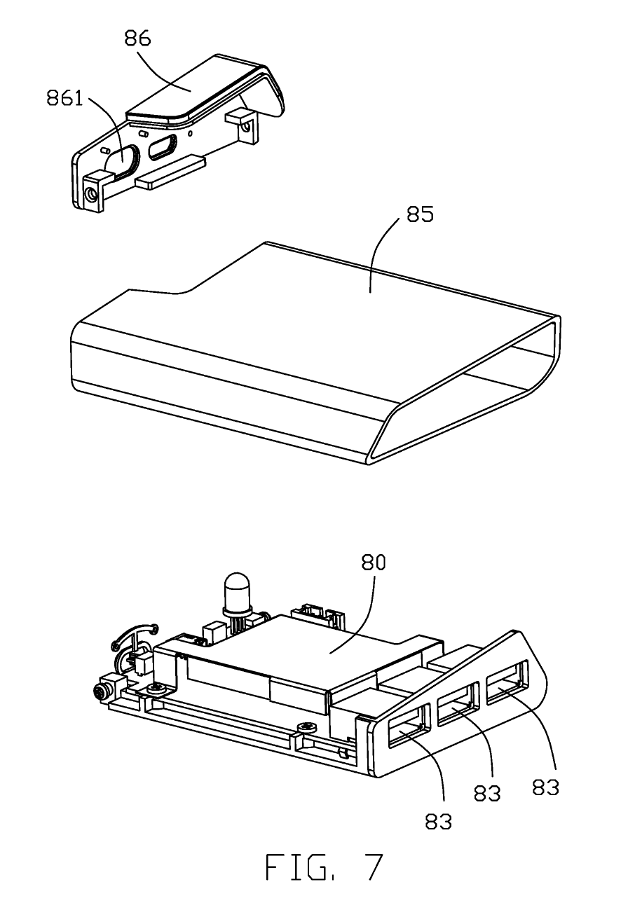

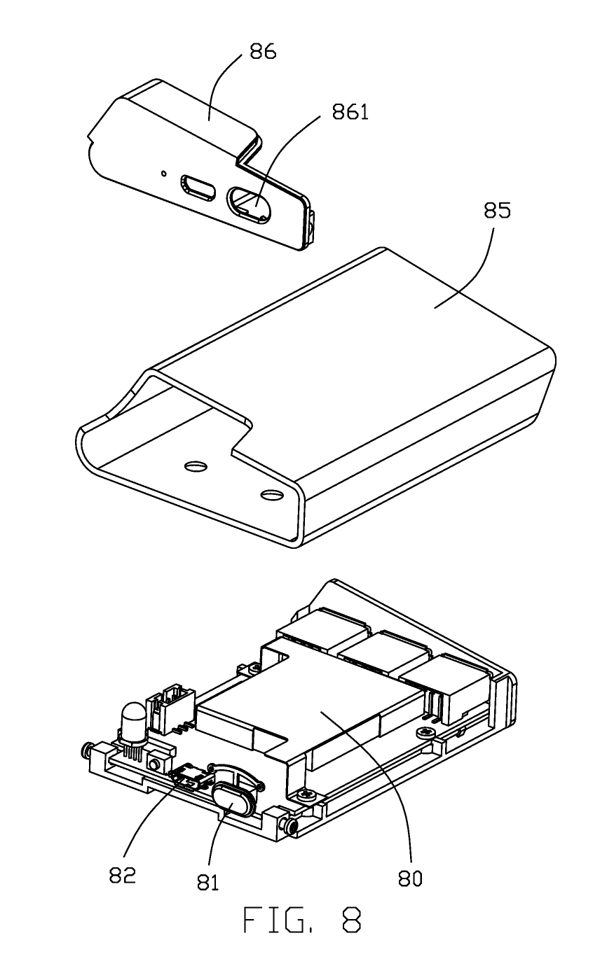

The sensor 1 and the data collection box 8 communicate with each other via the USB (Universal Serial Bus) wire or the blue tooth. Referring to FIGS. 6-8, the data collection box 8 can be located on one side of the equipment, and includes on one side a power key 81 for on/off usage, a Micro USB connection port 82 for charging, and on the other side three USB connection ports 83 for collecting the data from the sensors 1. The data collection box 8 further includes a printed circuit board assembly (PCBA) 80, an external shell 85 to cover the printed circuit board assembly 80, and a cover 86 upon one side of the external shell 83. The PCBA 80 may manage the data, the power key 81 and the Micro USB connection port 82 are located by one side of the PCBA 80, the cover 86 forms the opening 861 to expose the power key 81 and the Micro USB 82, while the USB connection ports 83 are located by the other side of the PCBA 80. The data collection box 8 may be connected to the sensor 1 via WPAN (Wireless Personal Area Network), e.g. the blue tooth.

The gateway 3 and the data collection box 8 are connected to and mutually communicate with each other via WPAN (Wireless Personal Area Network), e.g. the blue tooth. The data collected, via a one way transmission, from the sensor 1 via the USB wire 14 or the wireless can be managed in the data collection box 8 and transmitted to the gateway 3.

The intelligent power 2 mutually communicates with the gateway 3 via the low Rate Wireless Personal Area Network (LR-WPAN), e.g., ZigBee.

The gateway 3 and the room circumstance sensor 7 mutually communicate with each other via LR-WPAN, e.g. ZigBee. The circumstance sensors 7 may include the temperature sensor 71 and the humidity sensor 72. The room circumstance sensor 7 may transmit the related data to the gateway 3 via ZigBee and further to the Wi-Fi wireless network station and finally to the server system 6 so as to allow the user or the manager/coach to view the related data via the browser 9 or the application program 10. Therefore, the room circumstance may be timely adjusted, if necessary

The gateway 3 and the Wi-Fi wireless network station 5 communicate with each other via LAN (Local Area Network) or WAN (Wide Area Network), e.g., the Internet. The station 5 may include the Wi-Fi module and the wireless network station (hot spot or access point). The RFID system 4 includes the tag 41 corresponding the individual user, and the (card) reader 42 corresponding to the individual treadmill. The reader 42 is connected with the Wi-Fi wireless network station 5. When the user is using the machine, the tag 41 communicates with the reader 42 so the data is transmitted to the wireless network station and further to the web server 61 via LAN or WAN. The web server 61 cooperates with the data server 62 to obtain the stored corresponding data for further reviewing via the browser or the application programs. The all system not only identifies the user but also retrieve the old data and store the new data of the user for efficiently and intelligently managing the data for superior exercise.

The Wi-Fi wireless network station 5 communicate with the server system 6 via LAN or WAN. The server system 6 includes the web server 61 and the data server 62. The web server 61 interacts with the RFID system 4 for identifying the user's personal information for log-in use and the corresponding personal data collected from the sensor 1 and browsing. The data server 62 may store all the data of all users and all data of all machines. The server system 6 may transmit, via the WAN, the data derived from the user, the equipment, the intelligent power 2 and the room circumstance sensor 7, to either the browsers or the application programs of the mobile device, for viewing and/or further analyzing and making adjustment.

The server system 6 may provide partly the DMZ (Demilitarized Zone) or perimeter network 63 for limiting the approaching from the exterior to the enterprise server system for securing consideration.

The gateway 3 communicates with the data collection box 8, the intelligent power 2, the room circumstance sensor 7 and the Wi-Fi wireless network station 5. The gateway 3 transmit the data under different protocols so as to have the data derived from the data collection box 8, the intelligent power 2 and the room circumstance sensor 7 all directed toward the gateway 3 for integrating

The communication between the data collection box 8 and the sensor 1, and those between the gateway 3 and the data collection box 8/the intelligent power 2/the room circumstance sensor 7 via PAN while the communication between the gateway 3, the RFID system 4, the Wi-Fi wireless network station 5 and the server system 6 can be implemented via LAN and WAN.

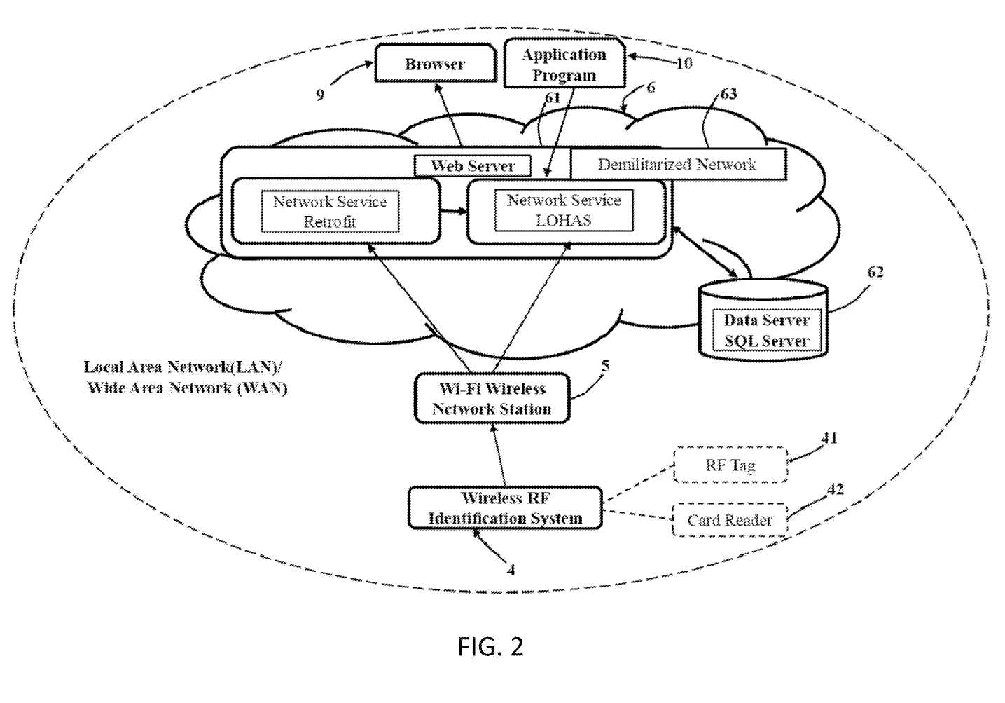

Referring to FIG. 2, the RFID system 4 includes the tag 41 corresponding the individual user, and the (card) reader 42 corresponding to the individual treadmill. The reader 42 is connected with the Wi-Fi wireless network station 5. When the user is using the machine, the tag 41 communicates with the reader 42 so the data is transmitted to the wireless network station and further to the web server 61 via LAN or WAN. The web server 61 cooperates with the data server 62 to obtain the stored corresponding data for further reviewing via the browser or the application programs. The all system not only identifies the user but also retrieve the old data and store the new data of the user for efficiently and intelligently managing the data for superior exercise.

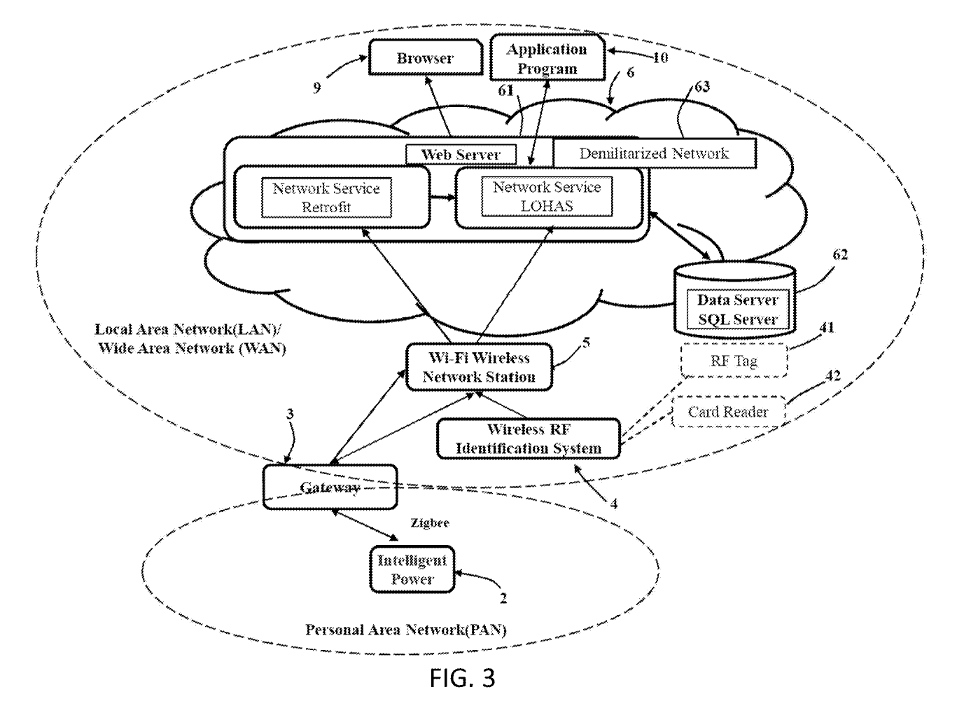

Referring to FIGS. 1 and 3, when the RFID system 4 transmits the data to the gateway 3 via the Wi-Fi wireless network station, the gateway 3 may activate the intelligent power ready in use for saving power in the regular time.

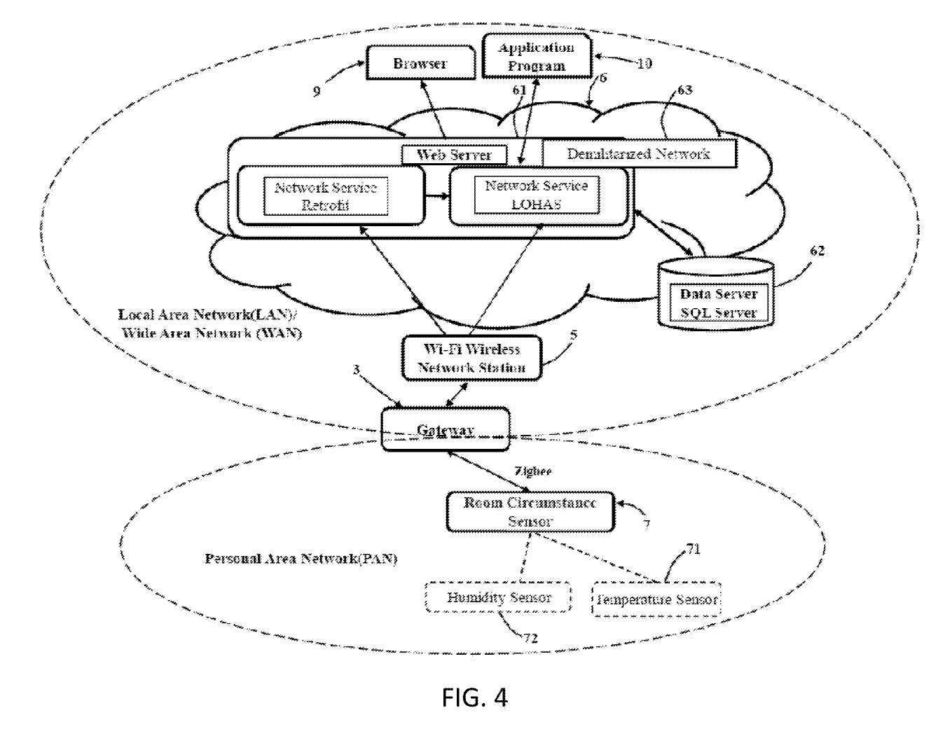

FIG. 4 shows the gateway 3 and the room circumstance sensor 7 mutually communicate with each other via LR-WPAN, e.g. ZigBee. The circumstance sensors 7 may include the temperature sensor 71 and the humidity sensor 72. The room circumstance sensor 7 may transmit the related data to the gateway 3 via ZigBee and further to the Wi-Fi wireless network station and finally to the server system 6 so as to allow the user or the manager/coach to view the related data via the browser 9 or the application program 10. Therefore, the room circumstance may be timely adjusted, if necessary.

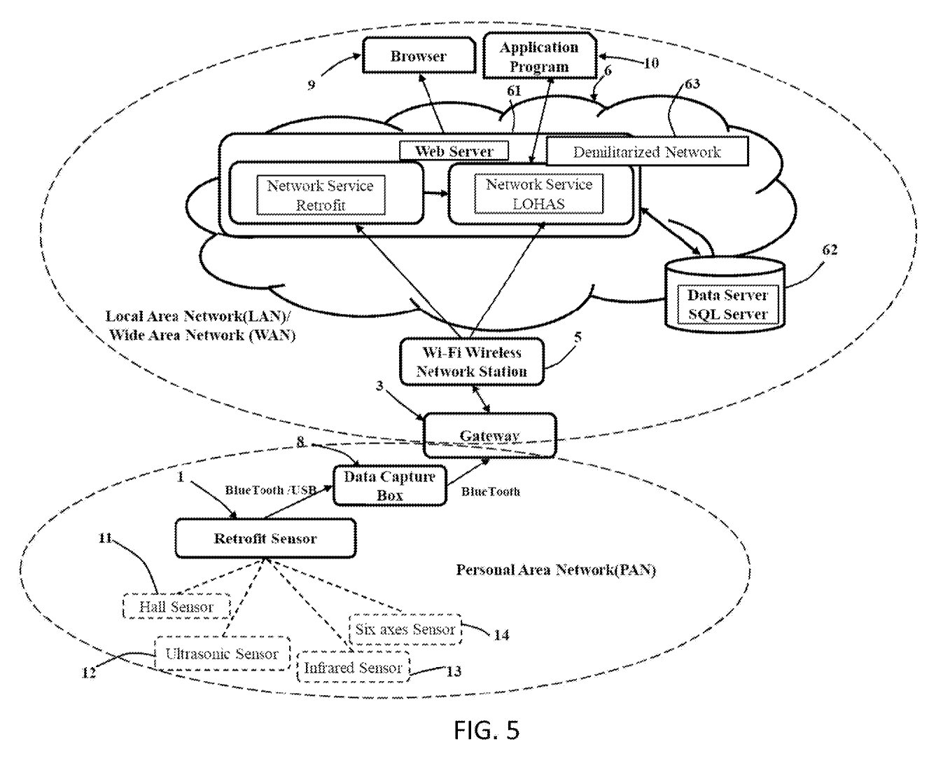

Referring to FIG. 5, when the user is using the machine, the sensor 1 transmits the data including the personal health information and the equipment operation information, to the data collection box 8 via the blue tooth or wires 14. The data collection box manages the collected data and transfer the corresponding data to the gateway 3 via blue tooth. The gateway 3 further transmits the data to the Wi-Fi wireless network station 5 and finally to the server 6 to allow the user or the manager to view the data in time either via the browser 9 or the app 10. Therefore, via this monitoring/computing, the user and the treadmill may interactively join each other for superior adjustment and control.

In conclusion, the data collection box 8 may collect the related data from the sensors 1 via either the wires 14 or the blue tooth and further transfer the computed data to the gateway 3. The invention also uses the gateway 3 to integrate, via the blue tooth or ZigBee transmission, the data collection box 8, the intelligent power 2, and the room circumstance sensor 7, which are under the different protocols, together. The Wi-Fi wireless network station 5 also collects the personal data via RFID system 4 and the computed data from the gateway 3 to the server system 6 for efficient management. In brief, the whole monitoring system uses the gateway 3 to collect the data including the information of the circumstance, that of the operation of the equipment, that of the user's instant operation and/or health condition and the intelligent power under a PAN on one hand, uses the Wi-Fi wireless network station 5 to communicate with the gateway 3 and the server 6 system and the RFID system 4 under either a LAN or WAN on the other hand, for efficiently managing both the equipment's and the user's condition.

What is claimed is:

1. An intelligent monitoring and computing system for use with an exercise equipment, comprising:
a gateway and an RFID (Radio Frequency Identification) system commonly connected to a Wi-Fi wireless network station;
a server system connected to the Wi-Fi wireless network station;
a data collection box connected to the gateway; and
sensors for sensing conditions of either a user or the exercise equipment connected to the data collection box; wherein
the data collection box collects data detected by the sensors.

2. The intelligent monitoring and computing system as claimed in claim 1, wherein communication between the gateway and the data collection box is under PAN (Personal Area Network).

3. The intelligent monitoring and computing system as claimed in claim 1, wherein communication between the sensors and the data collection box is under PAN (Personal Area Network).

4. The intelligent monitoring and computing system as claimed in claim 1, wherein communication between the Wi-Fi wireless network station and the gateway is under LAN (Local Area Network) or WAN (Wide Area Network).

5. The intelligent monitoring and computing system as claimed in claim 1, where an intelligent power is connected to the gateway under PAN (Personal Area Network).

6. The intelligent monitoring and computing system as claimed in claim 1, where a room circumstance sensor is connected to the gateway under PAN (Personal Area Network).

7. The intelligent monitoring and computing system as claimed in claim 1, communication between the data collection box and the gateway is wireless.
